(19) United States
(12) Patent Application Publication
(10) Pub. No.: US 2025/0325979 A1
(43) Pub. Date: Oct. 23, 2025

(54) MICROFLUIDIC DEVICE, SYSTEM AND METHOD FOR MANIPULATING A FLOWING FLUID

(71) Applicants: ALPHANOV, TALENCE (FR); UNIVERSITE DE BORDEAUX, BORDEAUX (FR); INSTITUT D'OPTIQUE THEORIQUE ET APPLIQUEE, PALAISEAU (FR); CENTRE NATIONAL DE LA RECHERCHE SCIENTIFIQUE, Paris (FR)

(72) Inventors: Sophie BOURZEIX, BORDEAUX (FR); Brahim LOUNIS, PESSAC (FR); Pierre NASSOY, BORDEAUX (FR); Amaury BADON, MÉRIGNAC (FR)

(21) Appl. No.: 18/870,544

(22) PCT Filed: May 30, 2023
(86) PCT No.: PCT/EP2023/064446

§ 371 Date: Nov. 29, 2024

(30) Foreign Application Priority Data
May 31, 2022 (FR) 2205233

(51) Int. Cl. B01L 3/00

(52) U.S. Cl. CPC B01L 3/502715; B01L 3/502761; B01L 3/502776; B01L 2200/027; B01L 2200/028; B01L 2200/0647; B01L 2300/1805; B01L 2300/1861

(57) ABSTRACT

The invention relates to a microfluidic device (100) comprising at least one sheath fluid inlet channel (1, 2) and a sample fluid inlet channel (3), and a common channel (4) configured to guide the sample fluid (20), with hydrodynamic focusing, and the at least one sheath fluid (21, 22) in the direction of at least two outlet channels (11, 12, 13).

According to the invention, the microfluidic device comprises heating means arranged to transmit over a short period of time an amount of heat localised in the at least one sheath fluid flow (21, 22) in the common channel (4) upstream of a junction between the at least two outlet channels (11, 12, 13) and the at least one sheath fluid having a thermal variation in viscosity suitable for diverting or extracting a portion (120, 130, 220) of the sample fluid selectively towards a given outlet channel.

### TECHNICAL FIELD

The present invention relates to the technical field of microfluidic devices and methods. More precisely, the present invention relates to a microfluidic handling device and method for controlling and quickly deflecting the flowing direction of a fluid. The present invention finds applications in accurate and quick handling of fluids or extraction of very small volumes from a fluid. The invention especially relates to the handling and sorting of individual particles of nanometric size in a fluid.

### PRIOR ART

In the above field, it is known to use flow cytometers to detect, count and identify cells or particles of micrometric size suspended in a flowing fluid by making them move, one by one and at high speed, through the beam of one or more lasers, then to sort them using sorting methods based on various techniques.

Advances in microscopy and biology have made it possible to focus on ever-smaller objects, in particular nano-objects smaller than 100 nm.

Traditional flow cytometers operate correctly only for objects of size larger than a micrometre. For objects of size smaller than 100 nm, the cytometers are currently limited by their detection capacity. Moreover, as regards the operation of nano-object sorting, the volumes of fluid generally used by the known cell sorters and the size of the drops used to encapsulate the objects to be sorted are not compatible with nanometric object sorting.

Different methods exist for sorting objects in a microfluidic chip. Some sorting methods are based on passive techniques. They may be based on inertial focusing methods or on the chip structure itself: this makes it possible to separate the objects into sub-populations as a function of their physical characteristics (volume, mass, . . . ). Other sorting methods, also passive, are based on the microfabrication of micrometric pillars and enable on-chip chromatography, but are applicable only for the micrometric objects or the polydisperse polymeric chains of micrometric length. These passive sorting methods does enable to sort the objects one by one as a function of a specific signal, for example fluorescence.

Micromechanical techniques enable to sort objects of micrometric size at a relatively slow sorting rate. Hence, the use of valves to separate cells, for example eukaryotic or prokaryotic cells, does not allow a sorting rate of more than 1 Hz.

Other active sorting techniques are based on the application of an electric or magnetic field. For example, the dieletrophoresis or the use of surface acoustic waves enable to reach a sorting rate of the order of the kHz on preformed micrometric drops encapsulating individual objects.

To our knowledge, there is currently no method for actively sorting individual nano-objects in a microfluidic chip capable of operating at a sorting rate higher than 1 kHz.

Apparatuses for concentrating nanoparticles by centrifugation, precipitation or isolation are well known. However, these techniques do not allow an individual sorting and/or a sorting based on a signal specific to the nanoparticles, for example a fluorescence signal.

For specific applications, microfluidic devices are also available for sorting particles pre-encapsulated into drops in oil. These devices require a previous encapsulation step. The volume of drops currently available is not compatible with the individual sorting of nanoparticles, as this requires excessive dilution and therefore a sorting time that is prohibitive for biological and medical applications.

The publication of Haneoka et al. “Microfluidic active sorting of DNA molecules labelled with single quantum dots using flow switching by a hydrogel sol-gel transition”, Sensors and Actuators B 159 pp. 314-320, 2011, describes a microfluidic device for sorting molecules in a fluid. On the other hand, the document EP 3218107 discloses devices for sorting microparticles in a flow of fluid. However, the switching frequency of these microfluidic devices is limited to a few hertz or to a few hundredth of hertz.

The U.S. Pat. No. 9,364,831 B2 discloses a microfluidic switch based on the absorption of an intense laser pulse to induce a gas bubble by cavitation. Such a microfluidic switch enables to laterally move polystyrene balls of 10 μm diameter at a switching frequency of 10 kHz. However, cavitation is liable to damage the integrity of nano-objects or the viability of fragile biological objects in suspension.

One of the objects of the present disclosure is to propose a device and method for manipulating and/or sorting in real time objects of micrometric to nanometric size, in suspension in a flowing fluid, at a high switching frequency, of the order of at least one kilohertz, and with innocuousness, i.e. without risk to damage the integrity of nano-objects or the viability of fragile biological cells in suspension in the fluid.

Another object of the present disclosure is to propose, for certain applications, a device and a method for manipulating and/or sorting nano-objects in suspension in a fluid, with or without a previous encapsulation step and using a fluid compatible with the analysis of nano-objects.

### DISCLOSURE OF THE INVENTION

For that purpose, the invention relates to a microfluidic device comprising at least one sheath fluid inlet channel and one sample fluid inlet channel, at least two outlet channels and a common channel arranged between said inlet channels and said outlet channels, the common channel being fluidically connected to said inlet and outlet channels, the sample fluid inlet channel being adapted to inject a sample fluid into the common channel, the at least one sheath fluid inlet channel being adapted to inject at least one sheath fluid into the common channel so as to allow a hydrodynamic focusing of the sample fluid into the common channel, the common channel being configured to guide the hydrodynamically focused sample fluid and the at least one sheath fluid towards said at least two outlet channels.

According to the invention, the microfluidic device includes heating means comprising a power source and at least one transducer, the heating means being arranged to transmit over a short duration an amount of heat localised in said at least one sheath fluid flow in the common channel upstream of a junction between said at least two outlet channels, the heating means being adapted to heat locally said at least one sheath fluid flow in the common channel and said at least one sheath fluid shows a thermal variation of viscosity adapted to selectively deflect or extract a portion of the sample fluid towards a determined outlet channel among the at least two outlet channels.

According to a particular and advantageous aspect, the at least one sheath fluid inlet channel comprises a first inlet channel and a second inlet channel, the first inlet channel being adapted to inject a first sheath fluid and the second inlet channel being adapted to inject a second sheath fluid.

According to a first embodiment, the heating means comprise at least one photo-thermal transducer and the power source comprises a laser source configured to generate a laser beam focused to said at least one photo-thermal transducer, said at least one photo-thermal transducer being adapted to absorb the laser beam and to transmit the heat induced by the laser beam to said at least one sheath fluid flow by conduction.

For example, said at least one photo-thermal transducer comprises a layer of gold or indium.

According to a particular and advantageous aspect of the first embodiment, said at least one photo-thermal transducer comprises at least one first photo-thermal transducer and at least one second photo-thermal transducer, said at least one first photo-thermal transducer and, respectively, said at least one second photo-thermal transducer being adapted to sequentially absorb the laser beam, so as to modify the flow rate of the first sheath fluid and, respectively, of the second sheath fluid to extract said portion of sample fluid.

Advantageously, said at least one first photo-thermal transducer comprises a plurality of photo-thermal transducers located on one side of the common channel and/or said at least one second photo-thermal transducer comprises a plurality of photo-thermal transducers located on an other side of the common channel with respect to a longitudinal axis of the common channel.

Advantageously, the heating means comprise at least one third photo-thermal transducer located on one side of the first outlet channel and/or at least one fourth photo-thermal transducer located on one side of the second outlet channel.

According to a second embodiment, the heating means comprise a laser source configured to generate a laser beam focused in the hydrodynamic sheath inside the common channel and the sheath fluid is adapted to absorb the laser beam to transform it into heat.

Advantageously, the laser source is adapted to emit a laser pulse having an energy between 10 nJ and 10 μJ over the short duration less than or equal to 50 μs.

According to a third embodiment, the heating means comprise at least one electro-thermal transducer adapted to locally heat the hydrodynamic sheath.

Advantageously, the microfluidic device comprises a thermoelectric module adapted to modify the temperature of either the whole microfluidic device or of the sample fluid and/or of the at least one sheath fluid upstream of the heating means.

Advantageously, the at least one sheath fluid has a temperature of 20° C., a viscosity between 2 mPa·s and 30,000 mPa·s and a thermal variation of viscosity between 0.2 mPa·s K⁻¹ and 3,000 mPa·s K⁻¹.

For example, the at least one sheath fluid comprises propylene glycol, linseed oil, or a mixture containing water and glycerol, or a mixture of water and carbohydrates.

Advantageously, the at least two outlet channels comprise a first outlet channel and a second outlet channel arranged or configured symmetrically with respect to the common channel.

As an alternative, the first outlet channel and the second outlet channel are arranged or configured dissymmetrically with respect to the common channel.

Advantageously, the at least one sheath fluid comprises particles, for example metallic, for example gold or indium, adapted to absorb the focused laser beam to transform it into heat.

The laser source operates in on-demand pulse mode or at a repetition rate less than or equal to 100 KHz.

The present disclosure also relates to a microfluidic system comprising a microfluidic device and comprising a detection module arranged upstream of the heating means, the detection module being configured to detect at least one signal representative of a nanoparticle in the sample fluid hydrodynamically focused into the common channel and means for feedback controlling the heating means as a function of the signal detected.

The present disclosure also relates to a microfluidic manipulation method comprising the following steps: (a) injecting a sample fluid into a common channel of a microfluidic device; (b) injecting at least one sheath fluid into the common channel to enable a hydrodynamic focusing of the sample fluid into the common channel; (c) applying a power source over a short duration to at least one transducer adapted to transmit an amount of heat localized in the at least one sheath fluid in the common channel upstream of a junction between said at least two outlet channels, the heating means being adapted to heat locally said at least one sheath fluid flow in the common channel and the at least one sheath fluid showing a thermal variation of viscosity adapted to selectively deflect or extract a portion of the sample fluid towards an outlet channel determined among the at least two outlet channels.

Advantageously, step c) comprises a time sequence of steps c1) and c2), a delay between step c1) and step c2) being adjusted in order to control the volume of the extracted portion of the sample fluid, wherein step c1) comprises applying the power source over a short duration to a first transducer located on one side of the common channel so as to transmit to said at least one sheath fluid in the common channel a first localized amount of heat and wherein step c2) comprises applying the power source over an other short duration to a second transducer located on an other side of the common channel with respect to a longitudinal axis of the common channel in order to transmit to said at least one sheath fluid in the common channel a second localized amount of heat.

Obviously, the different features, alternatives and embodiments of the invention can be associated with each other according to various combinations, insofar as they are not incompatible or exclusive with respect to each other.

### BRIEF DESCRIPTION OF THE DRAWINGS

Moreover, various other features of the invention emerge from the appended description made with reference to the drawings that illustrate non-limiting embodiments of the invention, and wherein:

FIG. 1 is a top view of the central portion of a microfluidic chip according to one embodiment;

FIG. 2 is a top view of a microfluidic chip according to one embodiment;

FIG. 3 is a view according to a cross-section AA of the central portion of a microfluidic chip shown in FIG. 2;

FIG. 4 is a schematic view of a microfluidic system according to one embodiment;

FIG. 5 is a top view of a microfluidic chip according to an embodiment having 2 outlet channels, with injection of a sample fluid and symmetric injection of the sheath fluid;

FIG. 6 is a view according to a cross-section BB of the central portion of a microfluidic chip shown in FIG. 5;

FIG. 7 is a top view of a microfluidic chip according to an embodiment having 3 outlet channels, with symmetric injection of the sheath fluid;

FIG. 8 is a top view of a microfluidic chip according to an embodiment having 2 outlet channels, with dissymmetrical injection of the sheath fluid;

FIG. 9 is a top view of a microfluidic chip during the application of a laser pulse on at least one heating area according to an example;

FIG. 10 is a top view simulation of a microfluidic chip during the application of an alternated sequence of laser pulses on two heating areas;

FIG. 11 is a simulation of the flow rates transmitted in two outlet channels during the application of an alternated sequence of laser pulses on two heating areas;

FIG. 12 schematically shows a sequence for extracting a portion of sample fluid towards a determined outlet;

FIG. 13 is a cross-sectional view of a microfluidic chip according to another embodiment, with a symmetry of revolution.

It is to be noted that, in these figures, the structural and/or functional elements common to the different alternatives can have the same references numbers.

### DETAILED DESCRIPTION

Generally, the present disclosure relates to a microfluidic device 100 also called microfluidic chip.

In the present document, it is meant by fluid a liquid, pure or mixed, or also a gel or an emulsion.

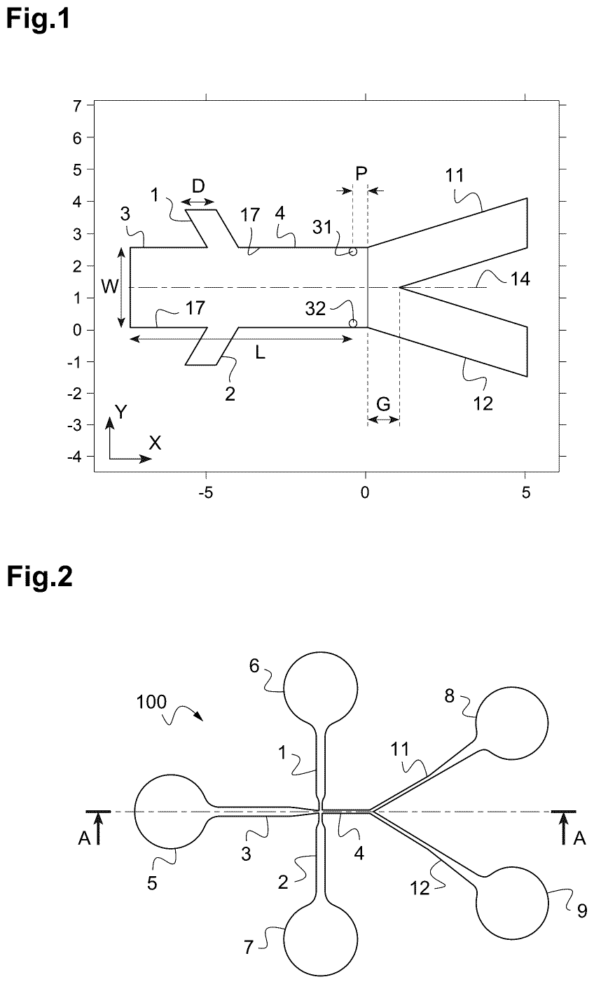

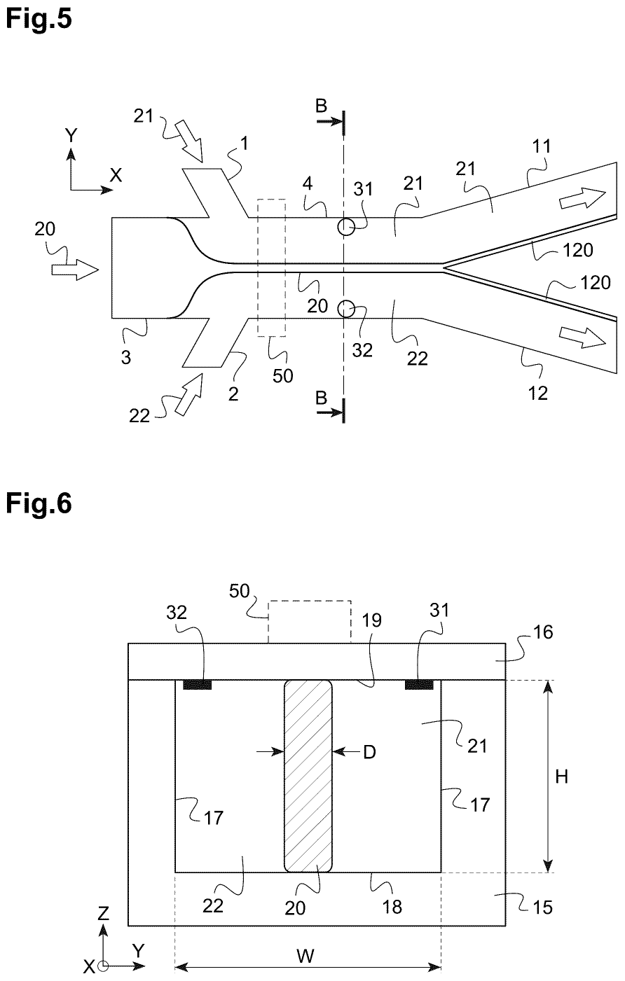

FIGS. 1 to 8 show a microfluidic device according to an embodiment of the invention. FIGS. 5 to 12 illustrate the operation of this microfluidic device.

### Device

The microfluidic device 100 includes channels 1 and/or 2, 3, 4, 11, 12, that mechanically guide a sample fluid 20 to be analysed and/or at least one sheath fluid 21, 22 from different source inlets 5, 6, 7 to different outlets 8, 9. The microfluidic device 100 is generally planar in shape. According to an alternative, the microfluidic device has a symmetry of revolution about a longitudinal axis. In this case, a single sheath fluid inlet channel can be used.

The microfluidic device 100 is for example fabricated from glass, ceramic or silicon. The microfluidic device can be fabricated monolithically or by assembling a support slide and a cover slide. The channels 1, 2, 3, 4, 11, 12 are formed, for example, by etching.

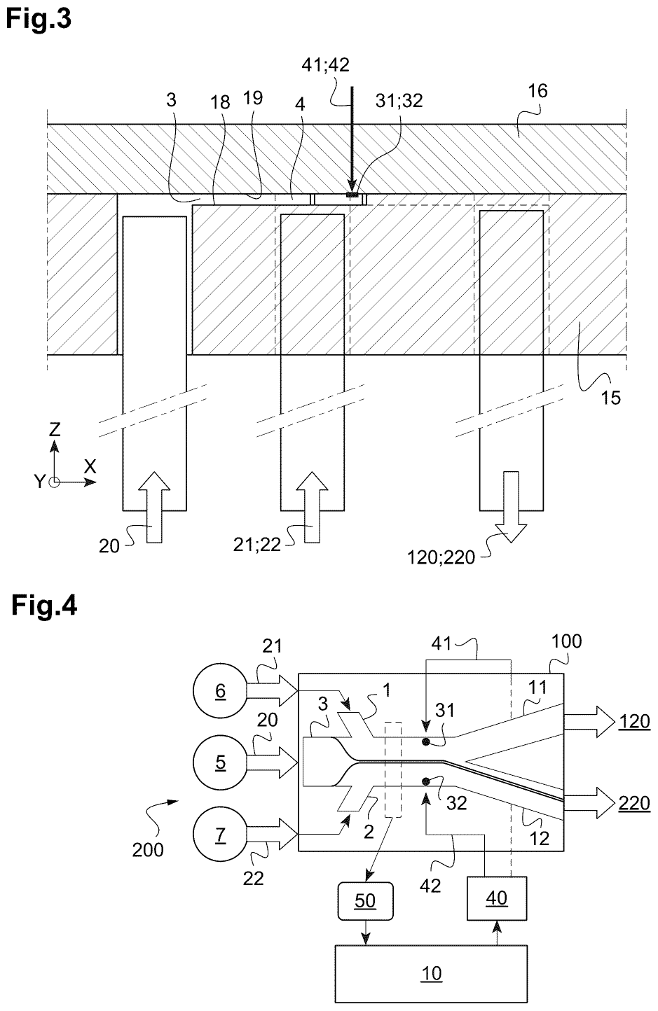

In an exemplary embodiment illustrated in FIGS. 3 and 6, the microfluidic device 100 is consisted by assembling two parts: a support slide 15 on which are formed the channels and a cover slide 16. The support slide 15 is for example fabricated from polydimethylsiloxane (PDMS). The slide 16 is preferably transparent to enable observation and detection of particles in the sample fluid. For example, the slide 16 is a microscope slide for observing the microfluidic device 100 under an optical microscope objective.

For example, as illustrated in FIG. 2, the microfluidic device 100 includes a source inlet 5 of the sample fluid 20 to be analysed, a source inlet 6 for a first sheath fluid 21 and an other source inlet 7 for a second sheath fluid 22. As an alternative, the first sheath fluid 21 and the second sheath fluid 22 are identical. As an alternative, the first sheath fluid 21 and the second sheath fluid 22 are stored in a single and same source tank. As an alternative, the sheath fluid is injected via a single sheath fluid inlet channel. The source inlets are generally connected by tubes to the tank for sample fluid and, respectively, sheath fluid(s). For example, the source inlets 5, 6, 7 are fluidically connected to syringes equipped with pumps to inject the sample fluid and, respectively, the sheath fluid(s) into the microfluidic device 100.

The microfluidic device 100 includes a common channel 4. The common channel 4 is connected to the different source inlets 5, 6, 7 by different inlet channels 1, 2 and 3. In particular, an inlet channel 1, respectively 2, connects the sheath fluid source inlet 6, respectively 7, to the common channel 4. An inlet channel 3 fluidically connects the sample fluid source inlet 5 to the common channel 4. In FIG. 1, the inlet channel 3 for the sample fluid 20 is located in the longitudinal axis 14 of the common channel 4 and the sheath fluid inlet channels 1, 2 are respectively located on opposite side faces of the common channel 4. By convention, as illustrated in FIG. 3, the inner surface of the common channel 4 on the side of the inlet 5 is here denoted lower inner face 18, or lower face. The inner surface on the side opposite to the inlet 5 is denoted upper inner face 19, or upper face. The inner surfaces of the common channel 4 transverse to the lower face 18 and to the upper face 19 rare denoted the side inner faces 17, or side faces. In the figures, an XYZ orthonormal Cartesian reference frame is represented. The common channel 4 extends generally in the XY plane, the longitudinal axis 14 of the common channel being parallel to the X axis. The common channel 4 generally has a cylindrical shape of generating line parallel to the longitudinal axis 14. According to other alternatives (not shown), the device includes other additional inlet channels.

At the other end of the common channel 4 is a junction, for example of the Y-junction type comprising at least one first outlet channel 11 and a second outlet channel 12. The outlets 8, and respectively 9, are connected to the common channel 4 of the microfluidic device via the first outlet channel 11 and, respectively, the second outlet channel 12. In the example illustrated in FIG. 1, the first outlet channel 11 and the second outlet channel 12 are of same size and are arranged symmetrically with respect to the longitudinal axis 14 of the common channel 4. As an alternative, the first outlet channel 11 and the second outlet channel 12 are of different size and/or are arranged dissymmetrically with respect to the longitudinal axis 14 of the common channel 4. For example, the first outlet channel 11 has a cross-section 20% smaller than the cross-section of the second outlet channel 12 so that the first outlet channel 11 has a higher fluidic resistance than the second outlet channel 12. This structural dissymmetry enables to direct the sample fluid 20 towards the second outlet channel 12 in steady state.

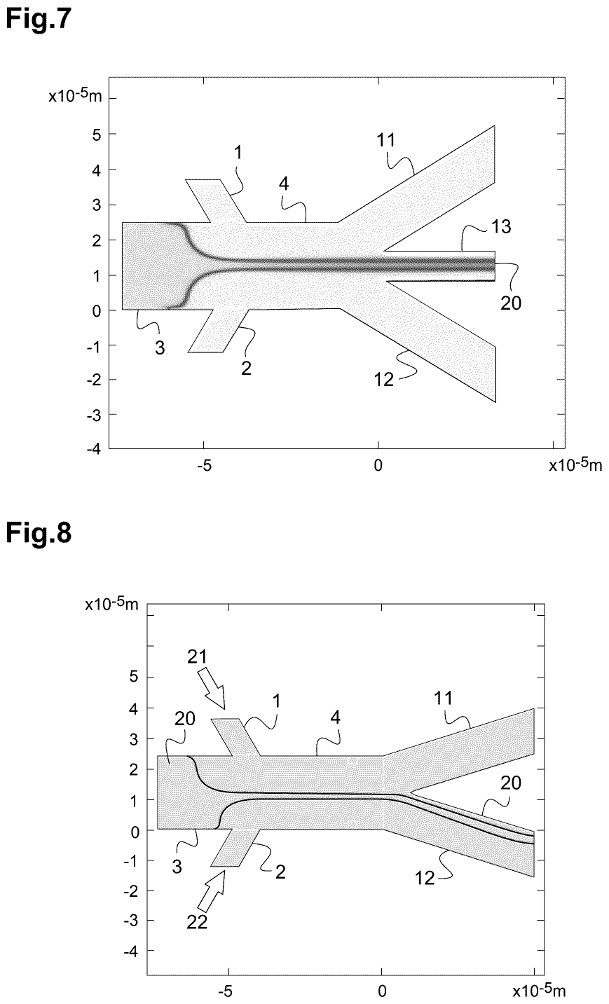

According to another alternative illustrated in FIG. 7, the microfluidic device 100 includes a third outlet channel 13. In this example, the third outlet channel 13 is arranged in the longitudinal axis 14 of the common channel 4. This configuration enables to sort particles according to two sorting criteria. According to other alternatives (not shown), the device includes more than three outlet channels to enable a sorting based on several criteria.

According to another alternative illustrated in FIG. 13, the microfluidic device 100 has, in its central portion, a symmetry of revolution about the longitudinal axis 14. In this configuration, the microfluidic device 100 includes a single sheath fluid inlet channel 1. The inlet channel 3 for the sample fluid 20 is located in the longitudinal axis 14. The inlet channel is connected to a truncated part arranged concentrically about the inlet channel 3. The inlet channel 1 enables to inject the single sheath fluid 21 concentrically about the sample fluid 20. This configuration enables the sample fluid 20 to be focused inside a cylindrical sheath for sheath fluid 21 in the common channel 4. In the example of FIG. 13, the first outlet channel 11 is located in the longitudinal axis 14. The second outlet channel 12 is connected to a truncated part arranged concentrically about the first outlet channel 11. The transducers 31, 32 are arranged in the common channel 4, for example on a side wall. Therefore, the sample fluid 20 that is not deflected by the heating means is collected via the first outlet channel 11. On the contrary, when the heating means deflect the sample fluid 20, the latter is collected by the second outlet channel 12. In the example illustrated in FIG. 13, the inlet channel 3 of the sample fluid 20, the common channel 4, the first outlet channel 11 and the frusto-conical parts connected to the sheath fluid inlet channel 1 and to the second outlet channel 12 are rotationally symmetric about the longitudinal axis 14. As an alternative, it is possible to combine the rotationally symmetric inlet channels with a common channel and outlet channels of planar geometry. According to another alternative, it is possible to combine inlet channels and a common channel of planar geometry with rotationally symmetric outlet channels.

Advantageously, the microfluidic device 100 includes a detection unit 50. The detection unit 50 is for example based on a system for detecting a fluorescence signal emitted by particles marked by a fluorescent marker and passing through the common channel 4.

According to the present disclosure, the microfluidic device 100 further includes at least one power source (optical or electric) and at least one transducer 31, 32 located in a heating area located in the common channel 4, upstream of the outlet channels 11, 12. In the case where a detection unit 50 is present, the transducer(s) 31, 32 are located downstream of the detection unit 50. The transducer 31, 32 transforms the power received from the power source into an amount of heat. The transducer is thus a very localized source of heat, which may be quickly switched. The transducer 31, 32 transmits the amount of heat to the sheath fluid so that the temperature of the sheath fluid increases locally.

The sheathing fluid is chosen to have a viscosity with a temperature dependence adapted, based on the amount of heat received, to modify the fluid flow in the microfluidic chip, while avoiding bubble generation through cavitation or boiling.

In the present document, it is meant by viscosity the dynamic viscosity of a fluid when the fluid is consisted of a single homogeneous component. In the case of a fluid composed of an inhomogeneous mixture, it is meant by viscosity the real or effective viscosity of the considered fluid.

The power source and the transducer are configured to induce a local increase of temperature in the heating area in which the sheath fluid forms a hydrodynamic sheath, so as to modify locally the flow velocity field in norm and direction, and consequently modify the sheath fluid flow rate. However, the intensity of the power input is below the cavitation bubble generation threshold in the sheath fluid. Moreover, the temperature of the sheath fluid remains below the boiling bubble generation threshold in the sheath fluid. In other words, the sheath fluid remains in the same physical state, before and after having received the amount of heat adapted to modify the fluid flow velocity.

As described in detail hereinafter, this arrangement enables a portion of the sample fluid to be selectively deflected towards a determined outlet channel among at least two outlet channels, at a very high rate. Depending on the signal detected upstream of the heating area, these heating means, localized and applied over a short duration, enable to extract a very small volume of sample fluid to sort individually a detected particle towards one or the other of the different outlet channels. The volume of extracted sample fluid is e.g. between 0.1 and 500 femtolitres (fl), e.g. from 0.1 to 10 fl or also from 10 fl to 100 fl, or also from 100 fl to 500 fl.

Several embodiments will be described, depending on the power source, type of heat transducer and sheath fluid used.

In a first embodiment, the power source comprises a laser source and the transducer comprises a solid element adapted to absorb the radiation of the laser source and to transmit the heat to the sheath fluid in an area of the hydrodynamic sheath. By convention, this type of transducer will be called photo-thermal transducer.

In a second embodiment, the power source comprises a laser source and the transducer is consisted by the sheath fluid that is adapted to absorb directly the radiation of the laser source in an area of the hydrodynamic sheath. The transducer is then of the photo-thermal type.

In a third embodiment, the power source comprises an electric current source and the transducer comprises a resistive or inductive dissipative element adapted to heat locally the sheath fluid inside the common channel 4 in an area of the hydrodynamic sheath. By convention, this type of transducer will be called electro-thermal transducer.

In all the embodiments, the sheath fluid 21, 22 is chosen so as to have a variable viscosity as a function of temperature rise, so as to modify the sheath fluid flow rate, in norm and/or direction. Advantageously, the sheath fluid 21, 22 has a strong variation of viscosity as a function of the temperature. Generally, the sheath fluid viscosity decreases when the temperature increases. For example, the sheath fluid has, at a temperature of 20° C., a viscosity between 2 mPa·s and 30,000 mPa·s, for example between 10 and 1,000 mPa·s and a thermal variation in viscosity between 0.2 mPa·s K⁻¹ and 3,000 mPa·s K⁻¹, preferably between 1 and 100 mPa·s K⁻¹ for example of at least 1 mPa·s per degree Kelvin in absolute value. Advantageously, the sheath fluid 21, 22 has a viscosity between 10 and 1,000 mPa·s at ambient temperature of 20° C. to enable a flow in the microfluidic device. By way of non-limiting example, the sheath fluid 21, 22 used is a liquid based on a mixture of water and glycerol (1,2,3-propanetriol of chemical formula HOH₂C—CHOH—CH₂OH) or a mixture of water and simple or complex carbohydrates (e.g. a syrup or agar-agar), or propylene glycol (propane-1,2-diol, of chemical formula CH₃—CHOH—CH₂OH) or linseed oil. Glycerol has a viscosity that varies greatly with temperature: its viscosity decreases 5,000 times more than that of water when heated by 1° C. On the other hand, pure glycerol has a very high viscosity, which requires pressure differentials that are difficult to implement in practice in a microfluidic system. Advantageously, a sheath fluid having both a dynamic viscosity less than 500 mPa·s and a viscosity dependence to temperature greater than 2 mPa·s per degree Celsius is selected. For example, a sheath fluid consisting of 10% water and 90% glycerol by mass concentration is used. In another example, a mixture consisting of 25% water and 75% glycerol by mass concentration is used.

The sample fluid 20 and the sample fluid(s) 21, 22 can be miscible or immiscible with each other. The sample fluid 20 is composed for example of water or a phosphate-buffered saline (PBS) solution containing micro-objects or nano-objects to be categorized and manipulated.

According to a particular aspect, the microfluidic device further comprises at least one thermoelectric module adapted to modify the temperature of either the whole microfluidic device or the sample fluid and/or the sheath fluid upstream of the heating area(s), for example at the inlet channels 1, 2 and/or 3 or the common channel 4. Such a thermoelectric module enables for example to maintain the sample fluid at a temperature compatible with specific biologic samples. According to a particular aspect, the thermoelectric module enables to adapt the temperature of the sheath fluid(s) so as to achieve optimum device operating temperature. For example, the thermoelectric module comprises a Peltier effect module. The temperature of the sheath fluid can thus be reduced, upstream of the heating area, by several degrees or even ten, twenty degrees, so that the sheath fluid has a higher coefficient of thermal variation in dynamic viscosity in absolute value for a same amount of heat supplied by the energy source, insofar as the sample contained in the sample fluid (or the core or analysis fluid) can tolerate such a temperature drop.

According to an example of the first embodiment, illustrated in FIGS. 5 and 6, the heating means include a first photo-thermal transducer 31 in a first heating area and a second photo-thermal transducer 32 in a second heating area. Advantageously, the first photo-thermal transducer 31 and the second photo-thermal transducer 32 are formed on an internal surface of the common channel 4 so as to be in contact with the sheath fluid during the operation of the microfluidic device. For example, the first photo-thermal transducer 31 and the second photo-thermal transducer 32 are arranged on the upper inner surface 19. The first photo-thermal transducer 31 and the second photo-thermal transducer 32 are disjoint and at a distance from each other of the order of the width W of the common channel 4, for example about 15 micrometres (μm). As an alternative, the first photo-thermal transducer 31 and the second photo-thermal transducer 32 are arranged on two opposite side surfaces 17 of the common channel. As another alternative, the first photo-thermal transducer 31 and the second photo-thermal transducer 32 are arranged on the lower face 18 of the common channel 8.

In this first embodiment, the photo-thermal transducers are not electrically connected to an electric current source, but are passive elements. According to the example of the first embodiment illustrated in FIG. 5, the first photo-thermal transducer 31 and the second photo-thermal transducer 32 each comprise for example a metal surface, for example gold or indium. This metal surface is formed for example by depositing a thin metal layer. More precisely, the first photo-thermal transducer 31 and, respectively, the second photo-thermal transducer 32 have a surface adapted to receive a laser beam 41, respectively 42. The thickness of the metal surface is generally of the order of magnitude of the skin depth at the wavelength of the laser used, for example between 10 nm and 500 nm. The material of the photo-thermal transducers 31, and respectively 32, and the wavelength of the laser source are adapted to allow the laser radiation 41, and respectively 42, of the laser source to be absorbed. In an exemplary embodiment, the first photo-thermal transducer 31 and the second photo-thermal transducer 32 are located inside the microfluidic device. In this case, the wall of the microfluidic device 100 is transparent to the laser radiation 41, respectively 42, so that it is absorbed by the first photo-thermal transducer 31 and/or respectively the second photo-thermal transducer 32, to be transformed into heat. That way, the first photo-thermal transducer 31 makes it possible to locally heat by conduction the first sheath fluid 21 in a first heating area of the hydrodynamic sheath upstream of the junction between the outlet channels 11 and 12. Similarly, the second photo-thermal transducer 32 makes it possible to locally heat by conduction the second sheath fluid 22 in a second heating area of the hydrodynamic sheath upstream of the junction between the outlet channels 11 and 12. The amount of heat deposited remains localized in the sheath fluid and is evacuated by the sheath fluid flow, so that the deposited heat does not reach the hydrodynamically focused sample fluid. In the case where the laser beam passes through the sheath fluid before reaching the transducer 31, 32, the wavelength of the laser beam is chosen so that the sheath fluid is transparent to the laser beam.

As an alternative to the first embodiment, the first photo-thermal transducer 31 and the second photo-thermal transducer 32 each comprise a rod passing through the wall of the microfluidic device. In this case, the laser beam 41, 42 is configured to be focused on the first transducer 31 and/or, respectively, the second transducer 32 outside the microfluidic device. By conduction, the rods enable the absorbed heat 22 to be transmitted to a first, respectively second, heating area of the hydrodynamic sheath upstream of the junction of the outlet channels 11 and 12.

In the first embodiment, the first photo-thermal transducer 31 and the second photo-thermal transducer 32 have a shape adapted to the device geometry, e.g. a square, disc or oblong shape. As an alternative, the first transducer 31 and the second transducer 32 have a rod or needle shape of axis Z. According to the example of the first embodiment illustrated in FIG. 1, the first photo-thermal transducer 31, and respectively the second photo-thermal transducer 32, are located at a distance P upstream of the junction with the first outlet channel 11, and respectively the second outlet channel 12. In an exemplary embodiment, the first photo-thermal transducer 31 and the second photo-thermal transducer 32 have a disc shape of diameter between 1 and 15 μm.

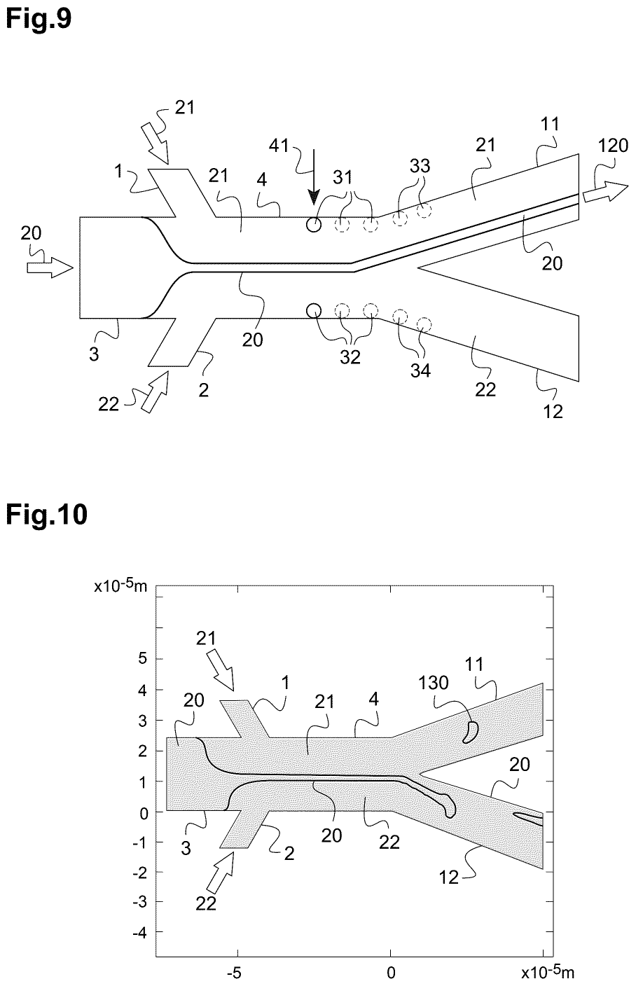

According to an alternative of the first embodiment, illustrated in FIG. 9, the microfluidic device includes a plurality of first photo-thermal transducers 31 arranged on an inner face of the common channel 4 upstream of the Y junction and/or a plurality of second photo-thermal transducers 32 arranged on the opposite, other side face 17, upstream of the Y junction. According to still another alternative, the first photo-thermal transducer 31 extends along one side of the common channel 4 and the second photo-thermal transducer 32 extends along the opposite side of the common channel 4.

As an option, the microfluidic device further includes at least one third photo-thermal transducer 33, respectively at least one fourth photo-thermal transducer 34, arranged on an inner face of the first outlet channel 11, and respectively the second outlet channel 12, i.e. downstream of the Y junction. As an alternative, the third photo-thermal transducer 33 extends along one side of the first outlet channel and/or the fourth photo-thermal transducer 34 extends along one side of the second outlet channel 12. The extended shape of the transducer enables to modulate the amplitude of deflection of the sample fluid. This amplitude modulation of the fluid deflection is used, for example, in the case of multi-criteria sorting to direct a volume of sample fluid between more than two outlet channels.

According to the second embodiment, the power source comprises a laser source similar to that described in connection with the first embodiment. However, instead of being directed towards a solid transducer, fixed with respect to the microfluidic device, the laser beam is directed directly to the fluid of the hydrodynamic sheath in the common channel. Indeed, in this second embodiment, the transducer 31, 32 is consisted by a portion of the sheath fluid that is illuminated by the laser beam and that is adapted to absorb directly the radiation of the laser source. The wavelength of the laser source is chosen so as to be absorbed by the sheath fluid 21 and/or 22. For example, the sheath fluid contains absorbent particles, e.g. gold particles in order to absorb a laser radiation of wavelength between 500 nm and 700 nm, or graphite particles. This second embodiment makes it easier to sweep the laser beam over a heating area of suitable size and dimensions as a function of the application, for example for multi-criteria sorting towards several outlet channels.

According to the third embodiment, the energy source comprises an electric current source and the transducers 31, 32 are of the electro-thermal type. For example, each electro-thermal transducer comprises a heating resistance or an inductive dissipative element. Such electro-thermal transducers are connected to an electric current source that is configured to sequentially power each electro-thermal transducer. The electro-thermal transducer 31, respectively 32, is in contact with the hydrodynamic sheath of the first, respectively second, sheath fluid in the common channel 4 to enable a thermal exchange. The electro-thermal transducers 31, 32 are electrically isolated with respect to the sheath fluid(s). An electro-thermal transducer may have various shapes. The different transducer shape and number alternatives described in relation with FIG. 9 also apply to this embodiment.

FIG. 4 shows a microfluidic system 200 adapted to control the operation of the microfluidic chip 100. The microfluidic system 200 includes a system of micro-pumps or syringe pumps for injecting the inlet fluids 20, 21, 22 into the inlets 5, 6, 7.

The microfluidic system 200 also includes a power source 40. In the first and second embodiment, the power source 40 is a laser source adapted to generate laser pulses. For example, the laser source 40 can be a modulated continuous laser beam, with pulse durations between for example 1 μs and 10 μs. As an alternative, the laser source 40 is a pulse laser generating ultra-short pulses, e.g. picoseconds or femtoseconds. In the third embodiment, the power source 40 is a power supply, adapted to deliver or not an electric current. The power source 40 makes it possible to supply a determined amount of energy to the transducers 31, 32 that transform this energy into a local heat source. In the first embodiment, the transducers 31, 32 are solid photo-thermal transducers, in the form of metal pellets or rods, for example. In the second embodiment, the transducers 31, respectively 32, are photo-thermal transducers each consisted by a portion of the sheath fluid that is illuminated by the laser beam 41, respectively 42. In the third embodiment, the transducers 31, 32 are solid electro-thermal transducers.

In the first and second embodiments, the laser source 40 is configured to generate a first laser beam 41 towards a first transducer 31 in a first heating area and respectively a second laser beam 42 towards a second transducer 32 in a second heating area. Advantageously, the first laser beam 41 is focused to the first transducer 31, respectively the second laser beam 42 is focused to the second transducer 32. For example, the first laser beam 41 is focused to an area with dimensions between 1 and 20 μm, for example a 3 μm-side square.

In the third embodiment, the electric current source 40 is connected to the electro-thermal transducers (e.g., heating resistances). The microfluidic system 200 comprises a switching system configured to apply one or more electric pulses selectively to the first transducer 31 and/or to the second transducer 32. In this case, the duration of an electric pulse adapted to heat the transducer is generally between 1 μs and 1 ms.

Optionally, the microfluidic system 200 includes a detection unit 50. The detection unit 50 is for example based on a system for detecting a fluorescence signal emitted by particles marked by a fluorescent marker in the hydrodynamically focused sample fluid and passing through the common channel 4. The detection unit 50 is positioned upstream of the transducers 31, 32 and the heating areas. Therefore, a signal representative of a particle is detected in an area of the sample fluid 20 that does not risk being disturbed by a rising in temperature of the heating area. This detection signal is transmitted to a controller 10 that pilots the power source 40, e.g. the laser source. A particle presence signal is detected before applying at least one laser or electric pulse to heat the sheath fluid downstream of the detection device. The distance between the detection unit 50 and the transducers 31, 32 is generally between 2 μm and 2 mm, for example between 20 and 500 μm, for example of 50 μm. Taking into account the fluid flow velocity, the duration between the detection of a particle and the heating to deflect the sample fluid is generally of between 1 μs and 100 ms, e.g. between 5 μs and 10 ms, e.g. of the order of 1 ms.

### Method

The operation of the microfluidic device 100 will now be described, first under steady-state fluid flow, then under impulse heating. For the sake of clarity, a planar microfluidic device (quasi 2D) comprising two sheath fluids is considered. However, taking into account the laminar nature of the microfluidic flows, the method also applies in the case of a single sheath fluid forming a sheath of revolution around the sample fluid.

The sample fluid 20 is injected in the centre of the common channel 4 via the inlet channel 3. Simultaneously, the first sheath fluid 21 and the second sheath fluid 22 are injected laterally on each side of the sample fluid 20. That way, thanks to an adjustment of the respective flow rates of the sample fluid 20, the first sample fluid 21 and the second sheath fluid 22, the microfluidic device makes it possible to form a hydrodynamic sheath in at least two dimensions on either side of the sample fluid 20 in the common channel 4. The sample fluid 20 is hydrodynamically focused in the common channel 4. Let's note W the width, H the height and L the length of the common channel 4. As a function of the ratio between the sample fluid flow rate and the sheath fluid flow rate, the sample fluid 20 has a reduced width D with respect to the width W by hydrodynamic focusing.

For example, in a microfluidic device as illustrated in FIGS. 2-3, the sample fluid 20 is injected with a flow rate of 20 μL·h⁻¹ and the first and the second sheath fluids 21, 22 have an identical flow rate 50 μL·h⁻¹. The width W of the common channel is 25 μm, the depth H of the common channel is 7 μm and the length L is about 74 μm. The width D of each input channel is of 11 μm. The distance P between the heating area 31, 32 and the beginning of the outlet channel 31, 32 is between 5 and 30 μm. The distance G between the beginning of the outlet channel 31, 32 and the tip of the Y junction is between 10 and 30 μm. The sample fluid 20 thus forms a fluid vein of width D of between 2 and 7 micrometres.

According to an example illustrated in FIG. 5, the microfluidic device includes two sheath fluid inlet channels 1 and 2 arranged symmetrically with respect to the longitudinal axis 14 and two outlet channels 11 and 12 arranged symmetrically with respect to the longitudinal axis 14. The same sheath fluid, e.g. a mixture composed of 25% water and 75% glycerol, is injected symmetrically via the first inlet channel 1 and the second inlet channel 2 with a same flow rate, e.g. 100 μL·h⁻¹. The sample fluid 20 comprises a carrier liquid based on PBS and dispersed nanoparticles or nano-objects. In this case, the hydrodynamically focused sample fluid 20 is located at the centre of the common channel 4, at equidistance from the two side faces 17.

Once focused, the sample fluid 20 is directed towards a junction with at least two branches according to the type of device (FIGS. 5, 7, 8).

First is considered a steady state or operating equilibrium of the microfluidic device, i.e. in the presence of sheath fluid and sample fluid flow rate and in the absence of application of a laser source or a power supply on the opto- or electro-thermal transducers 31, 32, 33, 34.

In the exemplary embodiment illustrated in FIG. 5, in steady state, the sample fluid 20 splits into two fluid veins 120 and 220 at the Y junction. The sample vein 120 and the first sheath fluid 21 flow in the first outlet channel 11 whereas the sample vein 220 and the second sheath fluid 22 flow in the second outlet channel 12. Each fluid vein 120, 220 shows approximately half the flow rate of the sample fluid 20 in the common channel 4.

In the exemplary embodiment with three outlet channels illustrated in FIG. 7, in steady state, the sample fluid 20 flows in the third outlet channel 13, in the longitudinal axis 14 of the common channel 4, whereas the first sample fluid 21 mainly flows in the first outlet channel 11 and the second sheath fluid 22 mainly flows in the second outlet channel 12.

As an alternative, when the arrangement of the inlet channels 1 and 2 is dissymmetric and/or when the flow rate of the first sheath fluid 21 is different from that of the second sheath fluid 22 (cf. FIG. 8), in steady state, the sample fluid 20 and the second sheath fluid 22 flow in the second outlet channel 12 whereas the first sheath fluid 21 mainly flows in the first outlet channel 11.

In connection with FIGS. 9 and 10, let's consider now an on-demand switching regime of the microfluidic device, i.e. in the presence of a sheath fluid and sample fluid flow rate and by applying a sequence of at least one pulse of a power source, laser or power supply, on at least one transducer 31, 32 in a heating area.

For the sake of clarity, a microfluidic device with two symmetric outlet channels according to the first embodiment is considered. The one skilled in the art will easily adapt the method to the other embodiments. As illustrated in FIG. 9, a first laser beam 41 is applied to the first transducer 31. The first laser beam 41 is configured to be absorbed by the first transducer 31. For that purpose, the first laser beam 41 is focused on the first transducer 31 and has a wavelength adapted to be absorbed by the first transducer 31. For example, a laser generating, on demand, pulses of wavelength between 500 nm and 800 nm, e.g. 660 nm, focused with a beam size of the order of 2 μm, is used. A laser pulse or a series of laser pulses is applied to heat the first transducer 31. The laser beam passes through the microfluidic device 100 before being absorbed by the first transducer 31. It is to be noticed that, in this example, the first laser beam 41 does not pass through the first sheath fluid 21 and is not absorbed directly by the sheath fluid. On the contrary, the energy of the laser beam is focused and absorbed by the first transducer 31. Under this illumination, the first transducer 31 warms and heats locally by contact the first sheath fluid 21 in a first heating area. It is observed that the heating area remains localized in the sheath fluid. For example, for a laser illumination of 70 nJ, the local rise in temperature is of 100° C. for 30 μs over an area of 3 μm in diameter. This local warming of the first sheath fluid 21 modifies the viscosity of the first sheath fluid 21, which modifies the flowing of the first sheath fluid 21 and therefore that of the sample fluid 20. In an example in which the first sheath fluid 21 is consisted of a mixture of 25% water and 75% glycerol, the viscosity of the first sheath fluid 21 varies locally due to the fact that the local rise in temperature is of 100° C. This local variation of viscosity modifies locally the direction and velocity of flow of the first sheath fluid 21. As illustrated in FIG. 9, this local heating makes it possible to deviate the sample fluid 120 so that it flows only in the first outlet channel 11, instead of being distributed between the two outlet channels, as in the steady state. Nevertheless, the local and short warming about the first transducer 31 in a first heating area is limited to a small volume of the first sheath fluid 21, which is evacuated by the sheath fluid flow and does not modify the temperature of the sample fluid 20 nor that of the second sheath fluid 22. Fragile particles located in the sample fluid that are to be detected and sorted are thus not affected by this local and short warming, despite the proximity of the local heating source.

Sequentially, the first laser beam 41 is interrupted and a second laser beam 42 is applied to the second transducer 32. The second laser beam 42 is configured to be absorbed by the second transducer 32. A same laser source 50 can generate alternately the first laser beam 41 and the second laser beam 42. As an alternative, a laser source is used to generate the first laser beam 41 and, sequentially, another laser source is used to generate the second laser beam 42. The second laser beam 42 is focused on the second transducer 32 and has a wavelength adapted to be absorbed by the second transducer 32. A single laser pulse or a series of laser pulses 42 is applied to heat the second transducer 32. In an example of the first embodiment, the second laser beam 42 passes through the microfluidic device 100 before being absorbed by the second transducer 32. Here again, the second laser beam 42 does not pass through the second sheath fluid 22 and is not absorbed directly by the sheath fluid. On the contrary, the energy of the second, pulsed laser beam 42 is focused and absorbed by the second transducer 32. Under this illumination, the second transducer 32 warms and heats locally by contact the second sheath fluid 22 in a second heating area. This local and short warming of the second sheath fluid 22 modifies the viscosity of the second sheath fluid 22, which modifies the flowing of the second sheath fluid 22 and therefore that of the sample fluid 20. This local heating enables to switch the orientation of the sample fluid 20 so that it then flows in the second outlet channel 12. The microfluidic device thus enables to switch on demand the sample fluid 20 from the first outlet channel 11 to the second outlet channel 12, and vice versa.

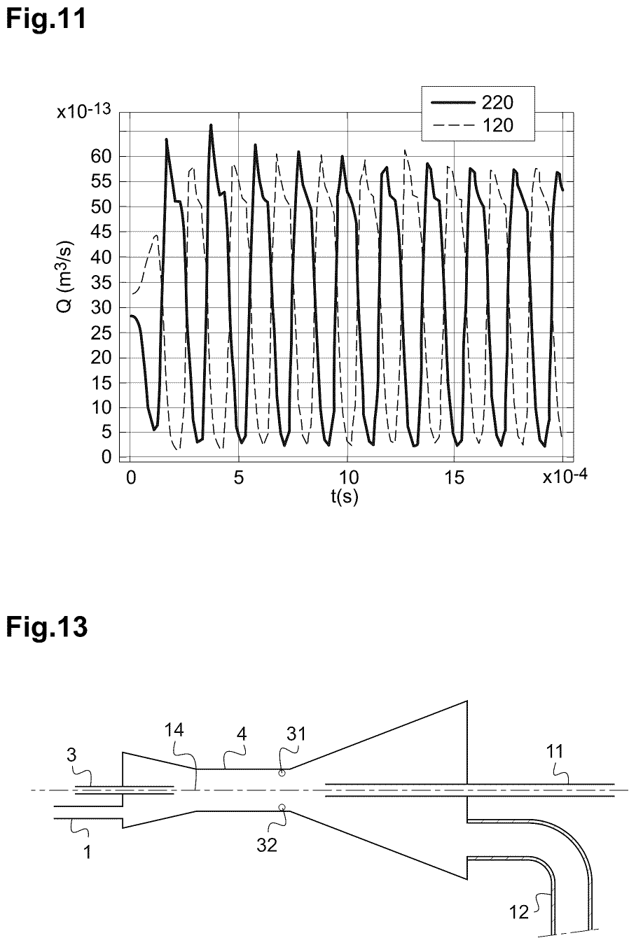

By heating either the first transducer 31 or the second transducer 32, the microfluidic device 100 enables to control the sample fluid outlet channel, as illustrated in FIG. 11.

By alternating sequential application of laser pulses to the transducers 31 and 32, the microfluidic device 100 enables to selectively extract a portion 120 of the sample fluid towards the first outlet channel 11 and/or to selectively extract another portion 220 of the sample fluid towards the second outlet channel 12. The microfluidic device 100 of the present disclosure makes it possible to manipulate objects of very small size, for example nano-objects or fragile biological cells, without altering their integrity or viability. Moreover, the microfluidic device 100 of the present disclosure makes it possible to achieve a switching or extraction frequency of at least 10 kHz, i.e. of several orders of magnitude higher than the maximum frequency achieved by most of the prior art microfluidic devices, in particular for the manipulation of nanoparticles.

Advantageously, the microfluidic system uses a particle detection signal coming from the detection unit 50 to trigger the heating of the first transducer 31 or of the second transducer 32. Based on the detection or not of the searched particles, it is then possible to extract a portion of the sample fluid towards one or the other of the outlet channels to perform a sorting as a function of the signal detected.

In the embodiment with three outlet channels, a detection signal capable of distinguishing two distinct particle categories is advantageously used so as to direct a first category of particles corresponding to a first detection signal towards the first outlet channel 11, and to direct a second category of particles corresponding to a second detection signal towards the second outlet channel 12. In the absence of detection signal, the sample fluid is directed, as in steady state, towards the third outlet channel 13, that corresponds to a discharge outlet. The particles of the first category are then collected via the outlet 8 whereas the particles of the second category are then collected via the outlet 9.

The device of the present disclosure has for advantage to enable the vein of the sample fluid 20 to be split into portions 120, 130, 220 without necessarily requiring prior encapsulation. Isolated sections of sample fluid flowing inside the sheath fluid are thus extracted. The isolated volume is generally less than one picolitre. In certain applications, the encapsulation step can be omitted for substantial time saving.

The present disclosure uses a flowing model in a shallow common channel approximation to model the operation of the microfluidic device. The flowing axis in the common channel is parallel to the X-axis of the orthonormal reference frame. The sample fluid 20 is for example consisted of water. The sheath fluids 21, 22 are consisted of a same mixture of water and glycerol. The viscosity of the sample fluid 20 and the sheath fluids 21, 22 is calculated from the publication Cheng N.-S. (Formula for viscosity of a glycerol-water mixture, Ind. Eng. Chem. Res., 47:3285-3288, 2008) to which the publication Volker et Kähler (Density model for aqueous glycerol solutions, Experiments in Fluids, 75, 2018) brought corrections in the volume model. A flow rate of 20 μL·h⁻¹ is applied to the sample fluid 20 and identical one of 50 μL·h⁻¹ to the first sheath fluid 21 and to the second sheath fluid 22. A non-slip condition is imposed on all the inner walls and the two branches of the Y junction form the two outlet channels 11, 12. The modelling based on a phase-field method highlights the interface between the sample fluid and the sheath fluid. The position of the interface is tracked by solving a transport equation. Moreover, minimising the mix energy makes it possible to determine the movements of the interface. This model is based on the following system of equations.

$${ρ}_{j} ( \frac{\partial {u}_{j}}{\partial t} + ( {u}_{j} \cdot ∇ ) {u}_{j} ) = - ∇ p + {η}_{j} {∇}^{2} {u}_{j} - 12 {η}_{j} \frac{{u}_{j}}{{e}_{𝓏}^{2}} \qquad [ Math . 1 ]$$

$${ρ}_{j} ∇ \cdot {u}_{j} = 0 \qquad [ Math . 2 ]$$

$${ρ}_{j} {C}_{pj} ( \frac{\partial {T}_{j}}{\partial t} + ( {u}_{j} \cdot ∇ ) {T}_{j} ) = {k}_{j} {∇}^{2} {T}_{j} + {Q}_{j} \qquad [ Math . 3 ]$$

$$\frac{\partial {ϕ}_{j}}{\partial t} + ( {u}_{j} \cdot ∇ ) {ϕ}_{j} = ∇ \cdot λ ∇ {ψ}_{j} \qquad [ Math . 4 ]$$

$${ψ}_{j} = - ∇ \cdot {ϵ}^{2} ∇ {ϕ}_{j} + ( {ϕ}_{j}^{2} - 1 ) {ϕ}_{j} \qquad [ Math . 5 ]$$

Math1 represents the conservation of momentum, Math2 represents the conservation of mass, Math3 represents the conservation of energy and Math4 and Math5 represent the phase field transport. The index j=1 represents the sample fluid and the index j=2 represents the sheath fluid. ρⱼ represents the density of each fluid phase, uⱼ=(uₓⱼ, uₓⱼ) represents the velocity field, ρⱼ the pressure, ηⱼ the dynamic viscosity e_{z} the channel depth of the microfluidic chip, Cₚⱼ represents the heat capacity, Tⱼ represents the temperature field, kⱼ the conduction coefficient and Qⱼ the source term, Φⱼ is a phase field variable and Ψⱼ is an auxiliary phase field variable. The parameter λ=3εσ/√8 is the free energy density of the mixture and σ the interfacial tension between phases 1 (sample fluid) and 2 (sheath fluid).

Results of this model are illustrated in FIGS. 8 and 10. The interface between the sample fluid and the sheath fluid is represented by a black line in FIGS. 8 to 10.

According to an operating mode, one or a series of laser pulses 41 is applied only to the first transducer 31 to selectively deflect the sample fluid towards the first outlet channel 11. The series of laser pulses 41 is interrupted, and then one or another series of laser pulses 42 is applied only to the second transducer 32 to selectively deflect the sample fluid towards the second outlet channel 12.

According to another operating mode, a single laser pulse 41 is applied over a short duration to the first transducer 31 to exact a portion 120 of the sample fluid and to direct it towards the first outlet channel 11.

According to another example (FIG. 10), a sequence comprising a first laser pulse 41 is applied to the first transducer 31 and a second laser pulse 42 is applied to the second transducer 32 to extract a portion 130 of the sample fluid towards the first outlet channel 11. For example, laser pulses each having a duration of 50 μs, with a cycle duration of 100 μm (i.e. a cyclic ratio of 50%) and a repetition rate of 10⁴ Hz are applied. Each laser pulse used to heat the sheath fluid on either side has a total energy of 70 nJ. The distance P from the heating area 31, respectively 32, to the beginning of the outlet channel 11, respectively 12, is of 5 μm.

In such a two-pulse sequence, it has been observed that adjusting the delay between the first laser pulse 41 and the second laser pulse 42, in an otherwise identical sequence, advantageously enables to adjust the volume of the portion 130 of the sample fluid extracted. This method makes it easy to size individually the volume of each portion 130 of the sample fluid extracted.

FIG. 11 represents a simulation of the sample fluid flow rate in the first outlet channel 11, and respectively in the second outlet channel 12, as a function of time, by applying a series of laser pulses 41, 42 alternated between the two heating areas 31, 32, at a frequency of 10⁴ Hz with the parameters indicated hereinabove. An oscillation of the sample fluid flow rate is observed in each outlet channel, which corresponds to a deflection of the fluid jet by an amplitude of about ±3 μm at the Y junction. A switching of the sample fluid between the two outlet channels is observed at the frequency 10⁴ Hz.

The oscillation frequency of the jet may reach several kHz, e.g. 2 kHz, 4 kHz or 10 KHz.

A simulation of the sample fluid flow rate in the first outlet channel 11 as a function of time has also been made by applying a series of laser pulses 41 with the same parameters as hereinabove for different values of the distance P between the heating area 31 and the Y junction, e.g. 10 μm and 25 μm, respectively. A time offset between the two flow rate curves is observed. It is deduced therefrom that the position of the heating area determines critically the switching of the sample fluid towards the first outlet channel 11 or towards the second outlet channel 12. This parameter P was not a priori identified as being critical to determine the outlet channel towards which the fluid portion 130 is extracted.

The simulation shows that the deflection of the sample fluid changes when the distance P varies, all other conditions remaining unchanged. For example, for a distance P equal to 5 μm, it is observed in the above simulation that the sample fluid is deflected towards the outlet channel that is on the same side as the heating area, with respect to the longitudinal axis 14. For a distance P equal to 10 μm, it is observed by a simulation based on the above model that the sample fluid is deflected towards the outlet channel that is on the same side as the heating area, with respect to the longitudinal axis 14. For a distance P equal to 25 μm, it is observed by simulation that the sample fluid is deflected towards the outlet channel that is on the opposite side to the heating area, with respect to the longitudinal axis 14.

Without being bound by a theory, the local heating of the sheath fluid in the part of the common channel in which the sample fluid is hydrodynamically focused, just upstream of the junction of the outlet channels, creates a pinching or twisting effect to the sample fluid, which enables to direct it towards either one of the outlet channels. According to the distance P between the heating area, the twisting of the sample fluid makes it possible to deflect it towards either one of the outlet channels. Moreover, this twisting effect makes it possible to cut the sample fluid into isolated sections selectively directed towards either one of the outlet channels. After the detection of a particle, it is then possible to isolate a portion of the sample fluid containing this particle and to deflect this portion of sample fluid containing the detected particle towards a determined outlet channel, in which it will be analysed. Particularly advantageously, the method according to the present disclosure makes it possible to extract a volume of sample fluid containing a single one detected particle and to deflect this droplet towards a predetermined outlet channel (see FIG. 10). The microfluidic device and method of the present disclosure makes it possible to guarantee a great purity of the extracted fluid and of the so-isolated nano-objects.

The microfluidic device of the present disclosure does not heat the sheath fluid upstream of the entry into the common channel nor upstream of the detection system. On the contrary, the microfluidic device of the present disclosure heats the sheath fluid in the common channel, downstream of the detection system and upstream of the outlet channels. The heating being very localised in the sheath fluid, the sample fluid remains at a constant temperature. The proximity between the detection unit 50, the heating areas 31, 32 and the outlet channels 11, 12 makes it possible to switch very quickly the sample fluid from an outlet channel towards another outlet channel while avoiding switching errors. A switching frequency of 2 kHz, 4 kHz or 10 kHz can be reached, i.e. several orders of magnitude higher than the microfluidic devices of the prior art.

The time sequence illustrated in FIG. 11 is an example to illustrate a sequence consisted of alternating heating cycles on a first transducer 31 and on a second transducer 32, with a repetition rate. This model makes it possible to evaluate the operation of the device and to determine the maximum frequency at which it can operates. In practice, the sequences are generally not predetermined, but adapted in real time as a function of the particles detected or not in the sample fluid.

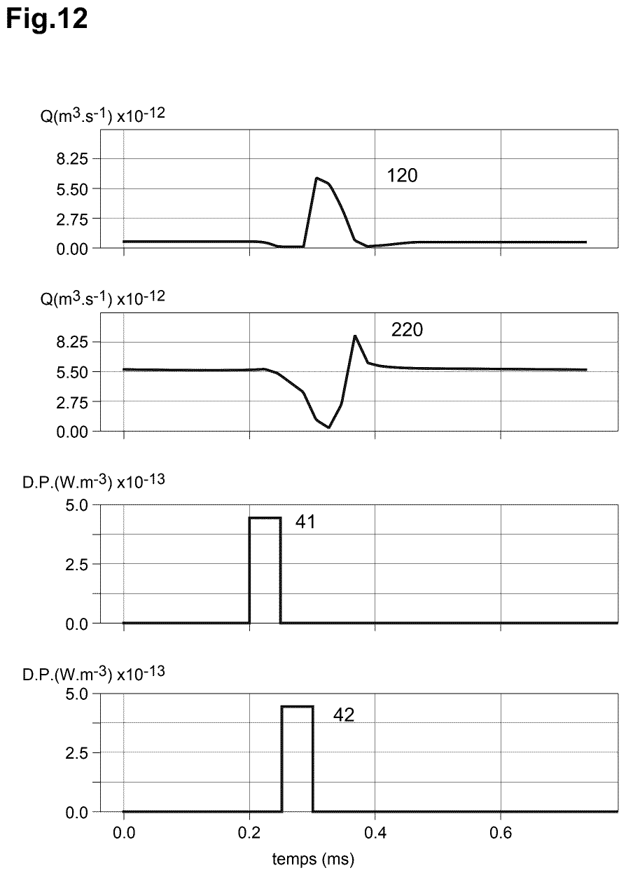

An example of operation consists in extracting a portion of the fluid containing a particle detected via the detection module 50. In this case, an isolated heating switching sequence is applied between the first transducer 31 and the second transducer 32, as illustrated in FIG. 12. In FIG. 12, the two lower curves show the power density applied by the laser beam 41 on the first photo-thermal transducer 31 and respectively by the laser beam 41 on the second transducer 32 as a function of time. In this example, it is observed that the laser pulses are not applied simultaneously on the two photo-thermal transducers, but successively. The duration of each laser pulse is here of the order of 50 μs. The two upper curves of FIG. 12 show the flow rate of the sample vein 120 extracted in the first outlet channel 11 and, respectively, the flow rate of the sample vein 220 extracted in the second outlet channel 12. Before the application of pulses, in steady state, the sample fluid vein flows in the second outlet channel 12. Just after the application of the two pulses, a very small volume of the sample vein 120 is extracted in the first outlet channel 11 during a short duration of the order of 100 μs. We then return to steady state.

Another example of operation consists in extracting successively two portions of the fluid, each containing a particle detected successively via the detection module 50. In this case, two successive heating switching sequences are applied between the first transducer 31 and the second transducer 32.

These different examples are thus based on the application of a time and spatial sequence of localised heating pulses, to allow extracting a section, i.e. a small volume, adapted to the sample fluid to be analysed.

In the case where a great concentration of objects (micro- or nano-objects) in suspension in the sample fluid 20, the present disclosure makes it possible to extract a volume (section) as small as possible, containing just one object per section. This splitting into small volumes makes it possible to count the objects one by one. The minimum volume that can be extracted is between 50 femtolitres and 1 picolitre according to the sample fluid flow rate and according to the delay between the laser pulses on the first transducer 31 and the second transducer 32.

However, a too small extracted volume can be a source of error if the object detected is not included in this small volume of fluid. Adjusting the time and spatial sequence makes it possible to adjust the extracted volume to optimize the sorting in different manners according to the applications. For example, to extract a determined fraction towards an outlet channel, a first pulse is applied to the first transducer 31, then successively a second pulse to the second transducer and a last pulse again to the first transducer 31. Such a sequence makes it possible to avoid hitches due to small residues of sample fluid, coming from a simple sequence with the first two pulses, and liable to move in a non-controlled manner towards either one of the outlets. Other, more complex sequences enable multi-criteria sorting.

The use of several heating areas 31 or 32 in the common channel, possibly completed by the use of auxiliary heating areas 33, 34 at the entry of the outlet channels, enable additional adjustments of the time sequence of heating pulses both spatially and temporally.

According to an alternative, the microfluidic device includes a plurality of heating areas 31, respectively 32, arranged on one side of the common channel 4, one after the other, in the fluid flowing direction, in other words in the direction of the longitudinal axis 14. This configuration makes it possible to apply a determined sequence of laser pluses on the successive heating areas 31, and/or respectively 32, following the fluid flow. This makes it possible to obtain a greater and scalable deflection of the sample fluid towards more than two outlet channels and enables a multi-criteria sorting.

Optionally, the microfluidic device includes one or a plurality of heating areas 33, respectively 34, arranged on one side of the first, respectively second, outlet channel 11, respectively 12. This configuration makes it possible to apply a determined sequence of laser pluses on the plurality of heating areas 33, and/or respectively 34, which enables for example to optimise a multi-criteria sorting.

The microfluidic device, system and method of the present disclosure enable to sort objects in a fluid, in particular micro-objects or even nano-objects smaller than 10 nm.

The present disclosure finds applications in biology (sorting of nanometric-sized objects), physics (granulometry) or chemistry (purification of nanometric probes).

Of course, various other modifications can be made to the invention within the scope of the appended claims.

1. A microfluidic device (100) comprising at least one sheath fluid inlet channel (1, 2) and one sample fluid inlet channel (3), at least two outlet channels (11, 12, 13) and a common channel (4) arranged between said inlet channels (1, 2, 3) and said outlet channels (11, 12, 13), the common channel (4) being fluidically connected to said inlet and outlet channels (1, 2, 3, 11, 12, 13), the sample fluid inlet channel (3) being adapted to inject a sample fluid (20) into the common channel (4), the at least one sheath fluid inlet channel (1, 2) being adapted to inject at least one sheath fluid (21, 22) into the common channel (4) so as to allow a hydrodynamic focusing of the sample fluid (20) into the common channel (4), the common channel (4) being configured to guide the hydrodynamically focused sample fluid (20) and the at least one sheath fluid (21, 22) towards said at least two outlet channels (11, 12, 13), wherein the microfluidic device includes heating means comprising a power source (40) and at least one transducer, the heating means being arranged to transmit over a short duration an amount of heat localised in said at least one sheath fluid (21, 22) flow in the common channel (4) upstream of a junction between said at least two outlet channels (11, 12, 13), the heating means being adapted to heat locally said at least one sheath fluid (21, 22) flow in the common channel (4) and in that said at least one sheath fluid shows a thermal variation of viscosity adapted to selectively deflect or extract a portion (120, 130, 220) of the sample fluid towards an outlet channel determined among the at least two outlet channels (11, 12, 13).

2. The microfluidic device (100) according to claim 1, wherein the at least one sheath fluid inlet channel (1, 2) comprises a first inlet channel (1) and a second inlet channel (2), the first inlet channel (1) being adapted to inject a first sheath fluid (21) and the second inlet channel (2) being adapted to inject a second sheath fluid (22).

3. The microfluidic device (100) according to claim 1, wherein said heating means comprise at least one photo-thermal transducer (31, 32) and the power source comprises a laser source configured to generate a laser beam (41, 42) focused to said at least one photo-thermal transducer (31, 32), said at least one photo-thermal transducer (31, 32) being adapted to absorb the laser beam (41, 42) and to transmit the heat induced by the laser beam (41, 42) to said at least one sheath fluid (21, 22) flow by conduction.

4. The microfluidic device (100) according to claim 2, wherein said at least one photo-thermal transducer (31, 32) comprises at least one first photo-thermal transducer (31) and at least one second photo-thermal transducer (32), said at least one first photo-thermal transducer (31) and, respectively, said at least one second photo-thermal transducer (32) being adapted to sequentially absorb the laser beam (41, 42), so as to modify the flow rate of the first sheath fluid (21) and, respectively, of the second sheath fluid (22) to extract said portion (130) of sample fluid.

5. The microfluidic device (100) according to claim 4, wherein said at least one first photo-thermal transducer (31) comprises a plurality of photo-thermal transducers located on one side of the common channel (4) and/or wherein said at least one second photo-thermal transducer (32) comprises a plurality of photo-thermal transducers located on an other side of the common channel (4) with respect to a longitudinal axis (14) of the common channel.

6. The microfluidic device (100) according to claim 3, wherein the heating means comprise at least one third photo-thermal transducer (33) located on one side of the first outlet channel and/or at least one fourth photo-thermal transducer (34) located on one side of the second outlet channel (12).

7. The microfluidic device (100) according to claim 1, wherein the heating means comprise a laser source configured to generate a laser beam focused in the hydrodynamic sheath inside the common channel (4) and wherein the sheath fluid is adapted to absorb the laser beam to transform it into heat.

8. The microfluidic device (100) according to claim 3, wherein the laser source is adapted to emit a laser pulse (41, 42) having an energy comprised between 10 nJ and 10 μJ over the short duration less than or equal to 50 μs.

9. The microfluidic device (100) according to claim 1, wherein the heating means comprise at least one electro-thermal transducer (31, 32) adapted to locally heat the hydrodynamic sheath.

10. The microfluidic device (100) according to claim 1, further comprising a thermoelectric module adapted to modify the temperature of either the whole microfluidic device (100) or of the sample fluid (20) and/or of the at least one sheath fluid (21, 22) upstream of the heating means.

11. The microfluidic device (100) according to claim 1, wherein the at least one sheath fluid (21, 22) has, at a temperature of 20° C., a viscosity between 2 mPa·s and 30,000 mPa·s and a thermal variation of viscosity between 0.2 mPa·s K⁻¹ and 3,000 mPa·s K⁻¹.

12. The microfluidic device (100) according to claim 11, wherein the at least one sheath fluid (21, 22) comprises propylene glycol, linseed oil, or a mixture containing water and glycerol, or a mixture of water and carbohydrates.

13. A microfluidic system (200) comprising a microfluidic device (100) according to claim 1, and comprising a detection module (50) arranged upstream of the heating means, the detection module (50) being configured to detect at least one signal representative of a nanoparticle in the sample fluid (20) hydrodynamically focused into the common channel (4) and means for feedback controlling the heating means as a function of the signal detected.

14. A microfluidic manipulation method comprising the following steps: (a) injecting a sample fluid (20) into a common channel (4) of a microfluidic device; (b) injecting at least one sheath fluid (21, 22) into the common channel (4) to enable a hydrodynamic focusing of the sample fluid (20) into the common channel (4); (c) applying a power source over a short duration to at least one transducer (31, 32) adapted to transmit an amount of localized heat in the at least one sheath fluid (21, 22) in the common channel (4) upstream of a junction between said at least two outlet channels (11, 12, 13), the heating means being adapted to heat locally said at least one sheath fluid (21, 22) in the common channel (4) and the at least one sheath fluid (21, 22) showing a thermal variation of viscosity adapted to selectively deflect or extract a portion (120, 130, 220) of the sample fluid towards an outlet channel determined among the at least two outlet channels. (11, 12, 13).

15. The microfluidic manipulation method according to claim 14, wherein step c) comprises a time sequence of steps c1) and c2), a delay between step c1) and step c2) being adjusted in order to control the volume of the extracted portion (130) of the sample fluid, wherein step c1) comprises applying the power source over a short duration to a first transducer (31) located on one side of the common channel (4) so as to transmit to said at least one sheath fluid (21) in the common channel (4) a first localized amount of heat and wherein step c2) comprises applying the power source over an other short duration to a second transducer (32) located on an other side of the common channel (4) with respect to a longitudinal axis (14) of the common channel in order to transmit to said at least one sheath fluid in the common channel (4) a second localized amount of heat.

16. The microfluidic device (100) according to claim 2, wherein said heating means comprise at least one photo-thermal transducer (31, 32) and the power source comprises a laser source configured to generate a laser beam (41, 42) focused to said at least one photo-thermal transducer (31, 32), said at least one photo-thermal transducer (31, 32) being adapted to absorb the laser beam (41, 42) and to transmit the heat induced by the laser beam (41, 42) to said at least one sheath fluid (21, 22) flow by conduction.

17. The microfluidic device (100) according to claim 2 wherein the heating means comprise a laser source configured to generate a laser beam focused in the hydrodynamic sheath inside the common channel (4) and wherein the sheath fluid is adapted to absorb the laser beam to transform it into heat.

18. The microfluidic device (100) according to claim 4, wherein the laser source is adapted to emit a laser pulse (41, 42) having an energy comprised between 10 nJ and 10 μJ over the short duration less than or equal to 50 μs.

19. The microfluidic device (100) according to claim 5, wherein the laser source is adapted to emit a laser pulse (41, 42) having an energy comprised between 10 nJ and 10 μJ over the short duration less than or equal to 50 μs.

20. The microfluidic device (100) according to claim 7, wherein the laser source is adapted to emit a laser pulse (41, 42) having an energy comprised between 10 nJ and 10 μJ over the short duration less than or equal to 50 μs.
